(19) United States
(12) Patent Application Publication
(10) Pub. No.: US 2005/0235797 A1
(43) Pub. Date: Oct. 27, 2005

(54) Decorative hole punch

(75) Inventor: Tokinori Takada, Chiba (JP)

Correspondence Address: GREENBLUM & BERNSTEIN, P.L.C., 1950 ROLAND CLARKE PLACE, RESTON, VA, 20191, US

(73) Assignee: KTF Corporation, Tokyo (JP)

(21) Appl. No.: 11/101,482

(22) Filed: Apr. 8, 2005

(30) Foreign Application Priority Data
Apr. 21, 2004 (JP) 2004-125944

(51) Int. Cl. B26F 1/14

(52) U.S. Cl. 83/684

(57) ABSTRACT

This invention provides a decorative hole punch of a structure such that anyone would be able to easily and safely return the cutting head to its original position by raising the arm after cutting holes, and such that its manufacturing process is simplified. The structure is such that, in a decorative hole punch comprising a frame, cutting head, guide hole, slit and a cutting head lever arm: the cutting head consists of a decorative hole cutting head formed in the shape of one of a variety of patterns, and also, the cutting head lever arm is pivotally supported by a support provided to one side of the external frame such that the back end of the arm rotates freely about a support pin in pivot holes so that the cutting head travels down vertically along the guide hole, and also is linked via a linkage pin to central linkage holes in a linkage area at the top end of the cutting head near the center of the arm.

### BACKGROUND OF THE INVENTION

1. Field of the Invention

The present invention relates not to a hole punch that cuts round holes for binding documents, but rather to a hole punch that cuts decorative holes in order to decorate paper or cloth or the like with decorative designs, and particularly to a decorative hole punch with a simplified assembly process and also a structure wherein the lever arm can be freely moved vertically so that the cutting head is easily removed from the guide hole and slit at the time of punching holes.

2. Description of Related Art

Conventional office hole punching equipment (punchers/hole punches) had the sole purpose of punching holes in the edges of documents in order to bind them. For this reason, single-hole punches were unusual and two-hole punching equipment was typically distributed and marketed, with multi-hole types of these office hole punches also existing.

The decorative hole punch according to the present invention is not used to punch file holes for office use, but rather it is a hole punch intended to meet the hobby demand for punching holes in the shape of geometrical patterns or animals, flowers, decorative letters, or many other shapes, being a hole punch belonging to the so-called realm of hobbies.

Conventional decorative hole punches have a structure wherein the hole cutting head is pressed down from above, so that the hole cutting head engages a guide hole, and thus paper or thin cloth or the like is cut and pierced by the cutting head that engages an anvil. After punching a hole, the cutting head is returned to its original position by the reaction force of a spring or other elastic member provided solely on the handle, and is thus automatically returned to its original position.

However, when holes are punched in thick paper or nonwoven fabric, the cutting head often does not return automatically with the force of the spring provided on the handle, so it was inconvenient in that the cutting head must often be returned to its original position by hand. In the case of punching round holes for ordinary office work, the round shape of the holes meant that there was little resistance to cutting by pushing down, so in the withdrawal of the cutting head after punching holes, the head was returned smoothly to its original position.

If the conventional structure is applied to a decorative hole punch without modification, this return to the original position after cutting becomes a problem. There was thus a need to develop a decorative hole punch wherein the arm of the punch is easily returned to its original position. In addition, with the conventional manufacturing method, the cutting head and the guide hole and anvil that engage the cutting head are manufactured as separate components, thus requiring complex and precise work in assembly so as to ensure that the central axes of each are precisely aligned to each other, along with post-processing steps to that end. Thus, the development of a decorative hole punch with a structure that does not require alignment of the central axes of the cutting head, guide hole and anvil had been desirable. A typical example of a decorative hole punch is the one taught in Unexamined Japanese Patent Application (Kokai) No. JP-A-Hei 11-235698.

An object of the present invention is to overcome the foregoing problems and provide a decorative hole punch of a structure such that anyone would be able to easily and safely return the cutting head to its original position by raising the arm after cutting holes, and such that its manufacturing process is simplified.

### SUMMARY OF THE INVENTION

In order to achieve the above object, the decorative hole punch according to the present invention comprises an external frame provided with a guide hole, anvil, slit and support, a cutting head, and a cutting head lever arm, wherein: the cutting head consists of a decorative hole cutting head formed in the shape of one of a variety of patterns, and also, the cutting head lever arm is pivotally supported via a support provided to one side of the external frame such that the back end of the arm rotates freely about a support pin in pivot holes so that the cutting head travels down vertically along the guide hole, and is also linked via a linkage pin to central linkage holes in a linkage area at the top end of the cutting head near the center of the arm.

In addition, the structure is such that the linkage area at the top end of the cutting head is formed such that the hole into which the pin is inserted is slightly larger than the diameter of the pin so as to accommodate yield in the arm.

Moreover, the pivot holes in the support provided to one side of the external frame are formed such that the inside diameter of the pivot holes is slightly larger than the outside diameter of the support pin so as to accommodate yield in the arm.

### BRIEF DESCRIPTION OF THE DRAWINGS

FIG. 1 is an overall perspective view of the decorative hole punch.

FIG. 2 is a side perspective view illustrating the interior structure of the decorative hole punch.

FIG. 3 is a side perspective view in the state with the arm pressed down.

FIG. 4 is a side view of the decorative hole punch.

### DESCRIPTION OF THE PREFERRED EMBODIMENTS

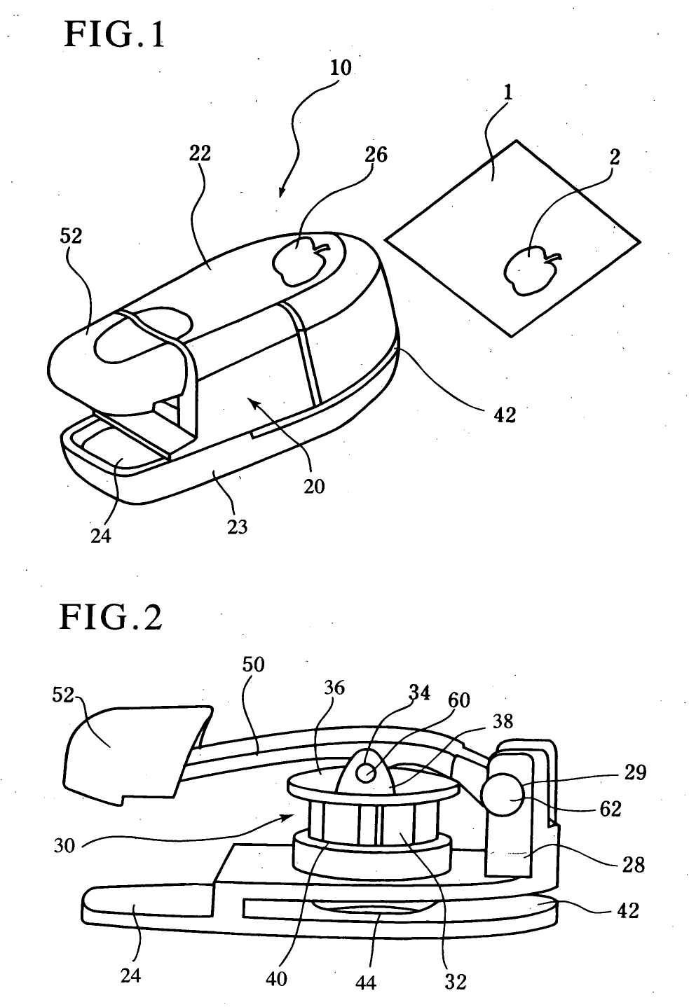

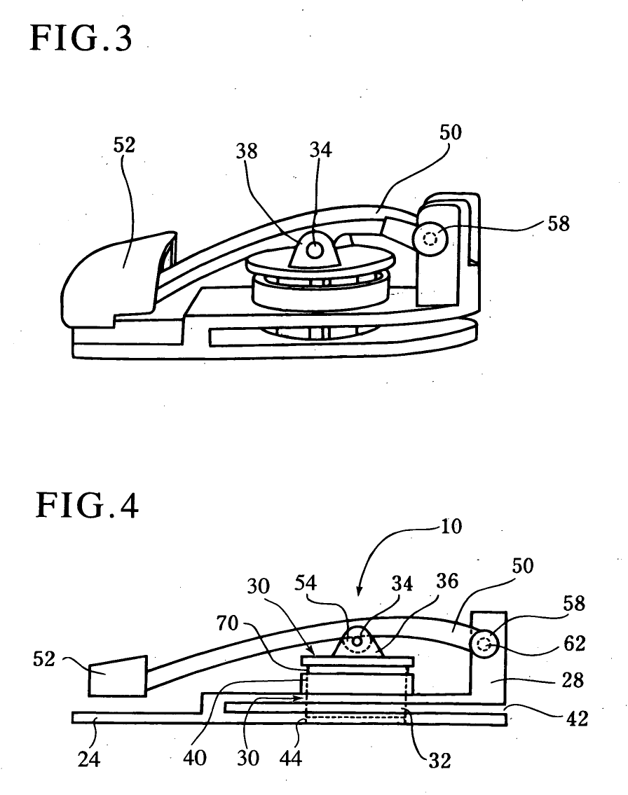

A decorative hole punch according to the present invention will now be explained in detail with reference to embodiments illustrated in the drawings. FIG. 1 is an overall perspective view of the decorative hole punch. FIG. 2 is a side perspective view illustrating the interior structure of the decorative hole punch. FIG. 3 is a side perspective view in the state with the arm pressed down. FIG. 4 is a side view of the decorative hole punch.

The decorative hole punch 10 according to the present invention consists of an external frame 20, cutting head 30, guide hole 40, slit 42, cutting head lever arm 50 and anvil 44. Part of a sheet of paper 1 or felt, cloth, thick material, film, adhesive paper or other material to be punched is inserted into the slit of the punch and the arm is pushed down to cut out a decorative hole 2.

### Embodiment 1

The external frame 20 constitutes the exterior of the decorative hole punch 10, consisting of a top cover 22 and a bottom (base) cover 23 for a base 24 upon which the anvil 44 is provided. In the embodiment shown in FIG. 1, the external frame is a rounded elliptical cylinder of a structure such that a sheet of paper 1 or felt, cloth, thick material, film, adhesive paper or other material to be punched is inserted into the slit 42 and the cutting head lever arm 50 is lowered downward, so that the linked cutting head 30 (see FIG. 3) is lowered under pressure to cut a decorative hole in the sheet inserted into the slit 42 with the cutting head. In this embodiment, the shape of the hole to be punched is indicated in the form of a pattern 26 on the top surface of the top cover 22.

Upon the base 24 are provided: a slit 42 into which the paper or other material to be punched is inserted, a guide hole 40 in the shape of various patterns formed in the center of the upper shelf forming the slit, an anvil 44 in the center of the lower shelf, and a support 28 that pivotally supports the cutting head lever arm 50 at either side of the distal end of the base. Pivot holes 29 are provided in the support with a support pin 62 inserted therein.

The cutting head 30 consists of a sharp cutting element that cuts holes in sheets, in this embodiment, consisting of a decorative hole cutting head 32 with the cutting head formed in the shape of an apple, animal or other shape. The cutting head 30 shears the material to be punched while engaging the anvil 44 to complete the punching of the material to be punched.

On the top end of the cutting head is provided a protruding linkage area 36 provided with central linkage holes 34 for linking to the cutting head lever arm 50 to be described later. The cutting head lever arm 50 is linked to the cutting head 30 via a linkage pin 60. Thereby, the cutting head 30 travels down the guide hole in response to the operation of the cutting head lever arm 50 being pushed down. As the cutting head is pushed down, the cutting head comes into contact with the upper surface of the material to be punched 1 that is inserted into the slit 42, and by the cutting action of meeting the anvil 44, the cutting head penetrates the material to be punched, thereby cutting the decorative hole 2.

The cutting head 30 is provided with a return spring 70, so after the cutting head lever arm 50 is pushed down and the punching action is complete, the cutting head lever arm 50 is returned to its original position by the elastic force of the spring. However, when punching holes in cloth, nonwoven fabric or other thick material, the cutting head will often remain engaged with the guide hole and anvil, and not be returned to its original position by the restoring force of the spring.

As a countermeasure to this, it is conceivable to provide a strong spring, but this is not realistic in consideration of the size of the entire piece of equipment.

The linkage area is of a shape nearly identical to that of the upper surface of the cutting head, being formed in the shape of a circle in this embodiment and provided with a protrusion 38, having opposing central linkage holes 34, that are provided at two places along the sides in axisymmetric positions. A linkage pin 60 is fit through a linkage hole in a protrusion 54 (to be described later) in the cutting head lever arm 50 and through the central linkage holes 34 in the protrusion, so that the cutting head lever arm 50 is linked to the cutting head 30.

The slit 42 is a horizontal groove provided in the side surface of the decorative hole punch so that the sheets of material to be punched can be inserted therein to be punched. The gap (width) of the slit 42 may be set arbitrarily. However, the material to be punched may conceivably include material other than paper, thin film or other materials that are easily sheared, so the gap of the slit should be set by determining the range of thicknesses that can be punched in consideration of felt or other materials that offer considerable resistance to punching holes.

The cutting head lever arm 50 has a front end where a handle 52 that moves up and down is provided, and a back end that is pivotally supported by the support 28 provided to the side of the external frame 20, with a protrusion 54 in which a linkage hole is provided formed in an intermediate portion where it crosses the cutting head.

On the back end of the cutting head lever arm 50 is formed a back-end linkage hole 58 where it enters the support, and a support pin 62 is inserted into the pivot holes 29 in the support 28 so that the cutting head lever arm 50 is pivotally attached to the external frame so that it is free to rotate. In addition, a linkage pin 60 is inserted into the central linkage holes 34 at the top end of the cutting head near the center of the cutting head lever arm 50, thus linking to the cutting head. When the handle 52 at the front end of the cutting head lever arm 50 is pressed down, the arm rotates about the support pin 62 at the pivotally supported rear end as an axis, and the cutting head linked near the center travels down in response. Accordingly, as the front end of the cutting head lever arm travels down, the cutting head also travels down vertically within the guide hole 40 and drops further until entering and penetrating the anvil 44. Thereby, a decorative hole is punched in the material to be punched inserted within the slit 42.

The trajectory of rotation of the cutting head lever arm 50 describes a circle centered upon the support pin 62. Accordingly, the trajectory of the central portion of the cutting head lever arm 50 is similarly an arc. However, the cutting head travels down vertically, so there is a certain amount of mismatch from the arc-shaped trajectory. To solve this problem, the linkage area at the top end of the cutting head is formed with the size of the hole (linkage hole) into which the linkage pin is inserted slightly larger than the diameter of the linkage pin, so as to accommodate the difference between the arc-shaped trajectory of the cutting head lever arm and the linear movement of the cutting head. Thereby, the arc-shaped trajectory is accommodated as a linear trajectory, thus ensuring a smooth down-travel action.

The structure is such that the handle is linked to the cutting head, thereby performing the same functions as in the prior art when pushed down, but also allowing it to be forcibly returned to its original state when it is not returned by the return spring.

In addition, the pivot holes 29 provided on the support 28 to one side of the external frame are formed such that the inside diameter of the pivot holes 29 is slightly larger than the outside diameter of the support pin 62 so as to accommodate movement that occurs when the cutting head lever arm 50 yields slightly so as to make the aforementioned correction between the arc-shaped trajectory and the linear motion of the cutting head. Thereby, even if the linkage between the cutting head lever arm 50 and the cutting head 30 is a firm connection that does not accommodate any yield, for example, the fulcrum of pivotal support can yield and absorb a certain amount of slack, thereby ensuring a smooth down-travel action.

The decorative hole punch according to the present invention has the constitution described in detail in the foregoing and offers the following specific advantages:

1. The arm is linked to the cutting head, so the cutting head can be moved regardless of the state of the cutting head. Even in the event that the cutting head is not automatically returned to its original position by the restoring force of the spring due to the material of the sheet to be punched, the arm is linked to the cutting head, so anyone can easily and safely lift the cutting head from the slit used for punching holes by lifting up the arm and returning it to its original position.

The cutting head, guide hole and anvil are formed with their central axes aligned, so complex axis alignment work in the assembly process can be eliminated, and the precision of assembly of the product can be improved.

2. The trajectory of rotary motion of a point near the center of the arm pivotally attached to one side of the external frame is shifted slightly from that which would result from pin positions that precisely follow the vertical motion of the cutting head, so by forming the hole into which the pin is inserted slightly larger than the diameter of the pin, the linkage area at the top end of the cutting head is able to move vertically even when linked securely.

3. The linkage holes provided to one side of the arm are also formed such that the inside diameter of the linkage holes is slightly larger than the outside diameter of the support pin so as to accommodate yield in the arm to follow the vertical motion of the cutting head linked to near the center of the arm, so even if the arm yields, the pivotally supported state can be maintained.

1. A decorative hole punch comprising an external frame provided with a guide hole, anvil, slit and support, a cutting head, and a cutting head lever arm, wherein:
the cutting head consists of a decorative hole cutting head formed in the shape of one of a variety of patterns, and also,
the cutting head lever arm is pivotally supported via a support provided to one side of the external frame such that the back end of the arm rotates freely about a support pin in pivot holes so that the cutting head travels down vertically along the guide hole, and is also linked via a linkage pin to central linkage holes in a linkage area at the top end of the cutting head near the center of the arm.

2. A decorative hole punch according to claim 1, wherein the linkage area at the top end of the cutting head is formed such that the hole into which the pin is inserted is slightly larger than the diameter of the pin so as to accommodate yield in the arm.

3. A decorative hole punch according to claim 1, wherein the pivot holes in the support provided to one side of the external frame are formed such that the inside diameter of the pivot holes is slightly larger than the outside diameter of the support pin so as to accommodate yield in the arm.
